(19) United States
(12) Patent Application Publication
(10) Pub. No.: US 2025/0026215 A1
(43) Pub. Date: Jan. 23, 2025

(54) ELECTRIC VEHICLE CHARGING STATION USING DETACHABLE CHARGING CABLE ASSEMBLY

(71) Applicant: MODERNTEC CO., LTD., Gyeongsangnam-do (KR)

(72) Inventor: SEONG DOO KIM, Gyeongsangnam-do (KR)

(21) Appl. No.: 18/776,425

(22) Filed: Jul. 18, 2024

(30) Foreign Application Priority Data
Jul. 20, 2023 (KR) 10-2023-0094858

(51) Int. Cl. B60L 53/18; B60L 53/66

(52) U.S. Cl. CPC B60L 53/18; B60L 53/665

(57) ABSTRACT

A charging station includes a charger configured to charge an electric vehicle and a charging cable assembly detachably provided on the charger. The charging cable assembly includes a charging connector configured to be linked to the electric vehicle for charging, a charging cable connected to the charging connector, and a cable connector provided at one end of the charging cable and detachably linked with the charger.

### CROSS REFERENCE TO RELATED APPLICATION AND CLAIM OF PRIORITY

This application claims the benefit under 35 USC § 119 of Korean Patent Application No. 10-2023-0094858 filed on Jul. 20, 2023 in the Korean Intellectual Property Office, the entire disclosure of which is incorporated herein by reference for all purposes.

### BACKGROUND

### 1. Field of the Invention

The present disclosure relates to an electric vehicle charging station using a detachable charging cable assembly, wherein an electric vehicle is allowed to be charged using a desired type of charging connector.

### 2. Description of the Related Art

In general, a charger is a means for charging an electric vehicle, and the means may include a charger for providing charging power, a charging cable formed extending in length from the charger, and a charging connector formed at an end of the charging cable and linked to an electric vehicle for charging.

However, charging connectors and charging ports provided at electric vehicles of various models are not of one type, but are of various types.

Therefore, the charging operation may be achieved by linking a charging connector that fits a charging port of a user's electric vehicle, and it is necessary to find a way to solve this inconvenience for electric vehicle user convenience.

The foregoing is intended merely to aid in the understanding of the background of the present disclosure, and is not intended to mean that the present disclosure falls within the purview of the related art that is already known to those skilled in the art.

### SUMMARY

The present disclosure is directed to providing a charging station, wherein a charging cable assembly including a charging cable and a charging connector is provided detachably from a charger, so the charging connector of a type that fits an electric vehicle to be charged is linked for use.

According to the present disclosure, there is provided a charging station including: a charger configured to charge an electric vehicle; and a charging cable assembly detachably provided on the charger,
wherein the charging cable assembly includes a charging connector configured to be linked to the electric vehicle for charging, a charging cable connected to the charging connector, and a cable connector provided at one end of the charging cable and detachably linked with the charger.

As described above, according to the present disclosure, when a user uses the charger to charge his or her electric vehicle, a suitable charging cable assembly is attached to the charger and the charging operation can be performed, thus fundamentally avoiding the situation in which charging is impossible due to another type of charging connector.

According to the present disclosure, in using the charger, since several charging cable assemblies of different types are placed in a storage part provided at the charging station, the charging cable assembly among the several charging cable assemblies that fits the user's electric vehicle is attached to the charger and the charging operation can be performed.

In addition, large-capacity charging cables are thick and heavy, but charging cable assemblies are separable from the charger, so a manager who manages the charging station can easily conduct maintenance.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating an example of charging an electric vehicle at a charging station according to an embodiment of the present disclosure;

FIG. 2 is a schematic diagram illustrating a charger of a charging station and a storage part storing a charging cable assembly therein according to an embodiment of the present disclosure;

FIG. 3 is a perspective view of a cable connector provided with a charging cable at a charging station according to an embodiment of the present disclosure;

FIG. 4 is a rear perspective view of FIG. 3;

FIG. 5 is a front view of a cable connector according to an embodiment of the present disclosure;

FIG. 6 is a perspective view of a charger connector according to an embodiment of the present disclosure;

FIG. 7 is a front view of a charger connector according to an embodiment of the present disclosure;

FIG. 8 is a schematic diagram illustrating a cable connector and a charger linked to each other according to an embodiment of the present disclosure;

FIG. 9 is a block diagram illustrating the relationship among a controller provided in a charger of a charging station, a storage part, and a management server according to an embodiment of the present disclosure;

FIG. 10 is a diagram illustrating a portion of a charging cable assembly according to an embodiment of the present disclosure;

FIG. 11 is a plan view of an example of a charging cable assembly according to an embodiment of the present disclosure;

FIG. 12 is a perspective view of a clamping member provided at a charger connector according to an embodiment of the present disclosure;

FIG. 13 is a diagram illustrating a charger connector and a cable connector coupled to each other by a clamping member according to an embodiment of the present disclosure;

FIG. 14 is a diagram illustrating several charging standards for charging connectors linked to electric vehicles;

FIG. 15 is a diagram illustrating another example of installation of a charger provided with charging cable assemblies according to an embodiment of the present disclosure; and

FIG. 16 is a diagram illustrating a plurality of numbered connection holes formed in a signal part of a cable connector according to the present disclosure.

### DETAILED DESCRIPTION OF THE INVENTION

Hereinafter, embodiments of the present disclosure will be described in detail with reference to the accompanying drawings. However, the technical idea of the present disclosure is not limited to the embodiments to be described and may be implemented in various forms. At least one of the elements between the embodiments may be selectively combined and/or replaced within the scope of the technical idea of the present disclosure.

In addition, terms in the embodiments of the present disclosure may be interpreted in the sense in which they would be generally understood by those skilled in the art, unless specifically defined, and generally used terms may be interpreted considering the contextual meaning of the related technology.

In addition, the terms of the embodiments of the present disclosure are for description of the embodiments and do not limit the present disclosure, and singular forms may be interpreted as including plural forms unless the context clearly indicates otherwise.

In addition, in the elements of the embodiments of the present disclosure, terms such as first, second, and third, or A, B, and C may be used, and these terms are only for distinguishing one element from other elements and does not limit order or sequence thereof.

In addition, in the embodiments of the present disclosure, when one element is described as “connected”, “linked”, and “coupled” to another element, it may mean that the element is directly connected, linked, or coupled to the other, and the two elements are indirectly connected, linked, or coupled to each other by intervening elements therebetween.

In addition, in the embodiments of the present disclosure, the placement, formation, and positioning of one element on, beneath, above, or under another element may mean that the element is directly or indirectly placed, formed, or positioned on, above, or under the other. Expressions such as up or down, and an upper or lower side may mean not only an upward direction but also a downward direction with respect to one element.

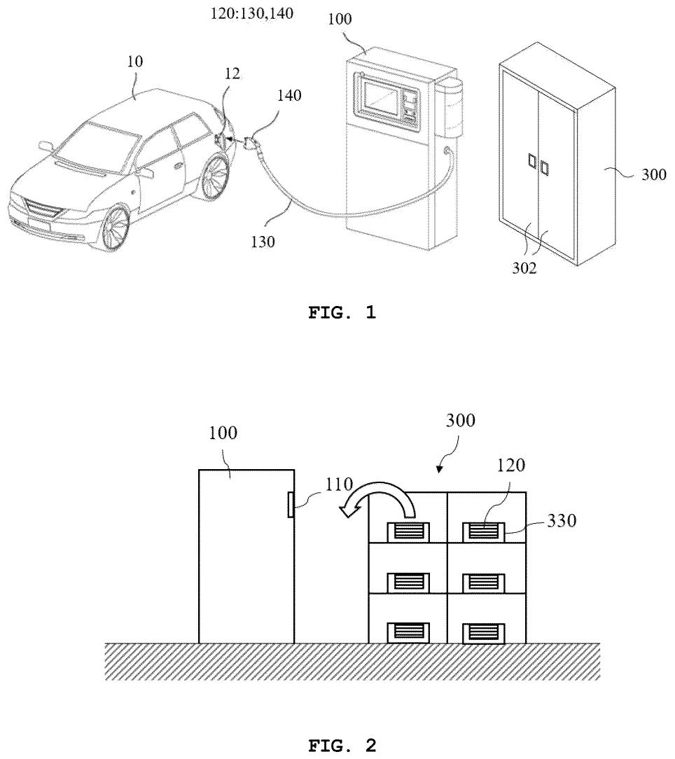

FIG. 1 is a diagram illustrating an example of charging an electric vehicle at a charging station according to an embodiment of the present disclosure. Referring to FIG. 1, a charging station according to an embodiment of the present disclosure may include a charger 100, a charging cable 130 formed extending in length from the charger 100, and a charging connector 140 formed at an end of the charging cable 130 and linked to an electric vehicle 10 for charging.

Hereinafter, a combination of the charging cable 130 and the charging connector 140 may be referred to as a charging cable assembly 120.

The charger 100 is classified as a rapid charger or a slow charger according to charging speed. The rapid charger may require about 30 minutes for full charging, and the slow charger may require about 6 hours for full charging.

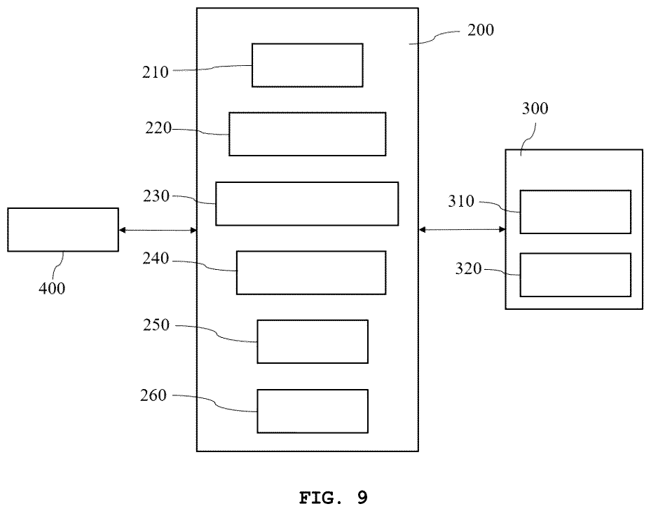

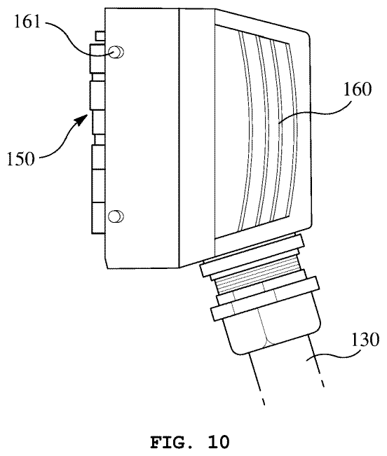

The charger 100 may detect whether the charger 100 is in use, that is, the charger 100 is performing charging. The detected information on whether charging is being performed may be provided to a management server 400 (see FIG. 9) and a user.

The charger 100 may transmit, to the management server 400, information on charging of the electric vehicle 10, for example, information on the current state of charge or the state of the battery of the electric vehicle 10 through connection to the electric vehicle 10. The management server 400 is communicatively connected to the charger 100 to transmit and receive information related to charging of the electric vehicle 10.

The information on charging may include information on the remaining battery life of the electric vehicle 10, the estimated time taken for the battery of the electric vehicle 10 to be fully charged, or errors in the charging operation.

Examples of the electric vehicle 10 may include a hybrid vehicle having both an electric motor and a typical internal combustion engine, and may include a vehicle as well as a motorcycle, a scooter, and an electric bicycle.

When the amount of electricity stored in the battery provided at the electric vehicle 10 is equal to or greater than a predetermined reference value or satisfies a predetermined charging completion condition, charging may be terminated.

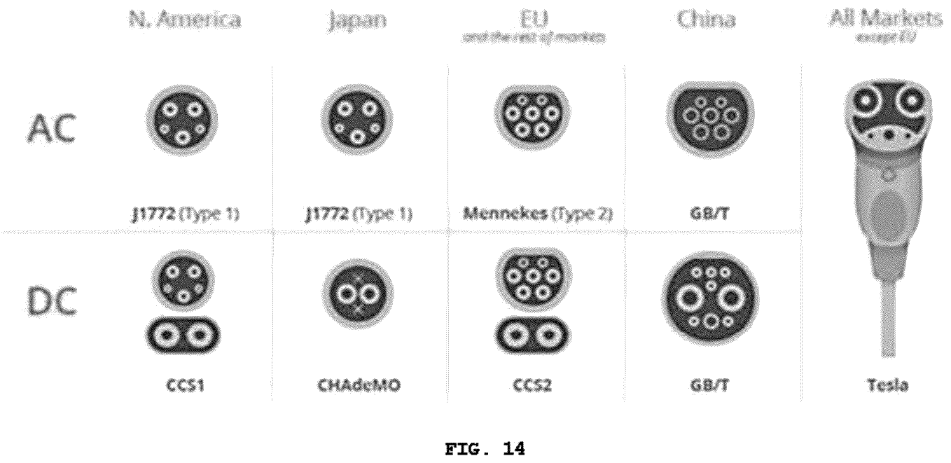

Referring to FIG. 14, there may be several types of charging connectors 140. The charging types of charging connectors 140 may be, for example, CCS1 in the United States, CCS2 in Europe, CHAdeMO in Japan, GB/T in China, and NACS in Tesla.

These several charging types of charging connectors 140 may be connected to charging cables 130, and the charging cables 130 may be integrally connected to the charger 100.

Accordingly, one charger 100 is provided with a particular type of charging cable assembly 120, and an electric vehicle user needs to find the charger 100 equipped with the type of charging cable assembly 120 that fits his or her electric vehicle 10 for charging.

The present disclosure provides a structure in which a charging cable assembly 120 is replaceably coupled to the charger 100, so a user can find and conveniently use the type of charging cable assembly 120 that he or she wants.

A charging cable assembly 120 according to the present disclosure may include a charging cable 130 and a charging connector 140 provided at one end of the charging cable 130 and linked to a charging port 12 of an electric vehicle 10 for charging. The other end of the charging cable 130 may be provided with a common cable connector 150 for link to the charger 100.

The charger 100 may be provided with a charger connector 110 to be linked to the cable connector 150.

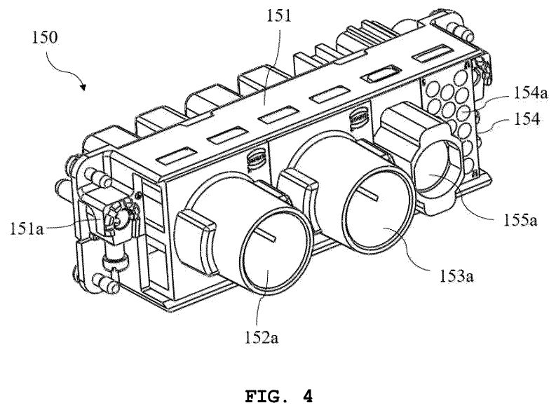

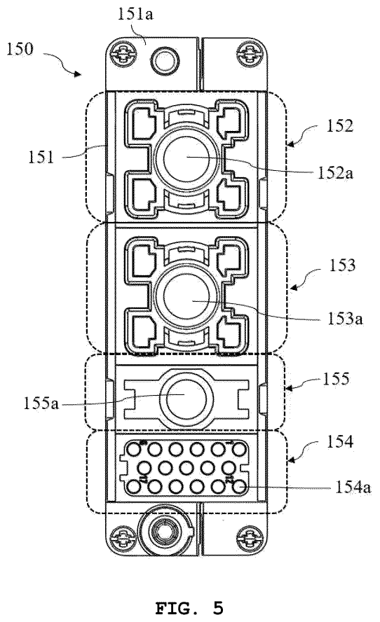

Referring to FIGS. 3 to 5, regarding the structure of the cable connector 150, the cable connector 150 may include a coupling frame 151, a power part provided on the inside of the coupling frame 151, a signal part 154, and a ground part 155.

The cable connector 150 serves as a male connector, so the power part, the signal part 154, and the ground part 155 may have protruding structures.

In addition, the exterior of the cable connector 150 may be provided with a hood 160. Accordingly, the coupling frame 151, the power part, and the signal part 154 are all embedded in the hood 160 and protected and invisible from the outside.

The power part may include a +DC part 152, which is a positive direct current power part, and a −DC part 153, which is a negative direct current power part.

The coupling frame 151 may have a coupling member 151a formed thereon for fastening with a fastening member when linked to the charger connector 110 of the charger 100. The coupling member 151a allows the fastening member, such as a screw or a bolt, to penetrate therethrough to be coupled to the charger connector 110 of the charger 100.

The coupling members 151a may be formed at the opposite sides of the coupling frame 151.

The +DC part 152 and the −DC part 153 may have a first connection conduit 152a and a second connection conduit 153a, into which power lines are inserted, formed respectively. A positive (+) direct current power line may be provided inside the first connection conduit 152a, and a negative (−) direct current power line may be provided inside the second connection conduit 153a.

A plurality of signal lines may be connected to the signal part 154. In an embodiment of the present disclosure, the signal part 154 may be provided with connection holes 154a for connection with 17 signal lines. However, without being limited thereto, connection holes 154a for connection with a larger number of signal lines may be formed.

Regarding the power part, a link pin (power pin) may be provided at an end of each of the power lines provided in the +DC part 152 and the −DC part 153.

The connection holes 154a of the signal part 154 may be provided with 17 link pins, and manufactured in modules to fit the types of the charging connectors 140.

In the present disclosure, the charging cable assembly 120 may have line connections by varying the number of line connections between the charger connector 110 and the signal lines of the signal part of the cable connector 150 according to the charging type, or may distinguish charging methods through short (connection) of the signal lines.

Referring to FIG. 16, for example, for convenience of description, assuming that a plurality of connection holes 154a provided at the signal part 154 of the cable connector 150 are 17 in number, numbered from 1 to 17, since communication methods vary depending on the charging types of charging connectors 140, the connection holes 154a numbered from 1 to 6 may be for the charger 100 to distinguish and recognize the charging types and to be in a suitable state.

Accordingly, the following is configured by the charging types of the charging connectors 140.

That is, in FIG. 16, the charging types may be distinguished according to the signal lines and the link pins (communication pins) inserted into connection holes 1 to 6, which are formed on the upper part, among the plurality of connection holes 154a formed in the signal part 154 of the cable connector 150.

The link pins (communication pins) may be provided in connection holes 1 and 2 for the CCS1 type, connection holes 1 and 3 for the CCS2 type, connection holes 1 and 4 for the CHAdeMO type, connection holes 1 and 5 for the GB/T type, and connection holes 1 and 6 for the NACS type.

Herein, for the CCS1 type, connection hole 7 may be for L1, connection hole 8 may be for N, connection hole 9 may be for PE, connection hole 10 may be for PP, and connection hole 11 may be for CP.

For the CCS2 type, connection hole 7 may be for L1, connection hole 8 may be for N, connection hole 9 may be for PE, connection hole 10 may be for PP, connection hole 11 may be for CP, connection hole 12 may be for L2, and connection hole 13 may be for L3.

For the CHAdeMO type, connection hole 8 may be for N, connection hole 9 may be for PE, connection hole 10 may be for PP, connection hole 11 may be for CP, connection hole 14 may be for signal 1, connection hole 15 may be for signal 2, connection hole 16 may be for CAN+, and connection hole 17 may be for CAN−.

For the GB/T type, connection hole 9 may be for PE, connection hole 10 may be for PP, connection hole 11 may be for CP, connection hole 14 may be for signal 1, connection hole 15 may be for signal 2, connection hole 16 may be for CAN+, and connection hole 17 may be for CAN−.

For the NACS type, connection hole 9 may be for PE, connection hole 10 may be for PP, and connection hole 11 may be for CP.

Herein, N may denote a communication neutral line, and L may denote a power live line (electric power line), wherein L1, L2, and L3 may denote a first power live line, a second power live line, and a third power live line, respectively. Herein, power may be applied to L1, L2, and L3 in the case of an AC charging type, or power may not be applied thereto in the case of a DC charging type, such as the charging connectors of the present disclosure.

CP denotes a control pilot, which is a communication function for monitoring between an electric vehicle and a charger (EVSE). The charger may determine the amount of current that can be supplied now, and the electric vehicle may determine the amount of current used for charging, through communication therebetween. In addition, when this line is short-circuited, power supply to N and L may be cut off.

PP denotes a proximity pilot, which may be a signal indicating the connection between the charging cable and the electric vehicle, and PE denotes protective earth, which may be a ground wire for communication.

Signals 1 and 2 may denote a first signal line and a second signal line, respectively.

CAN denotes a controller area network, which may be a communication method for a vehicle.

In the plurality of connection holes 154a formed in the signal part 154 of the cable connector 150, the link pins (communication pins) to which the signal lines are connected may be arranged differently according to the charging types. In other words, the link pins (communication pins) may be inserted only into the signal part 154 of the cable connector 150, and the signal lines (provided with resistors) may be connected thereto.

The cable connectors 150 having these different arrangements may be linked to the charger connector 110 of the charger 100. Accordingly, in order for the charger 100 to be internally linked to all charging types of charging cable assemblies 120 and perform the charging operation of electric vehicles, a controller 200 may perform switching between communication types that fit the respective charging cable assemblies 120.

Herein, all insertion holes 114a formed in a charger signal part 114 of the charger connector 110 corresponding to a female connector are provided with link members to which the link pins of the cable connector 150 are linked.

Referring to FIG. 14, for example, the CCS1 type and the CCS2 type differ in the number of communication pins which is two. CCS2 may be a method for connection by allocating two additional link pins.

Each communication follows a communication standard appropriate to that communication method, which may be configured as follows.

In the case of CCS1, communication is performed through two power lines using the power-line communication (PLC) method, and incidental control is performed through five link pins (communication pins) shown in the upper position in the drawing. The line connection operation may be performed using the power parts provided at the cable connector 150 and five signal lines among the signal lines connected to the signal part 154. Herein, the ground wire is common, so the ground wire may be also subjected to the line connection operation.

In the case of CCS2, similarly to CCS1, incidental control may be performed through the seven link pins (communication pins) in the upper position.

CHAdeMO requires eight link pins (communication pins). When the signal lines corresponding thereto are connected, the communication method may be determined by checking a short state (connection state).

In the case of GB/T, the communication method may be determined through seven link pins (communication pins), excluding power lines.

In the case of NACS, using the same power-line communication (PLC) method as in CCS1, the communication method may be determined through three link pins (communication pins), excluding power lines.

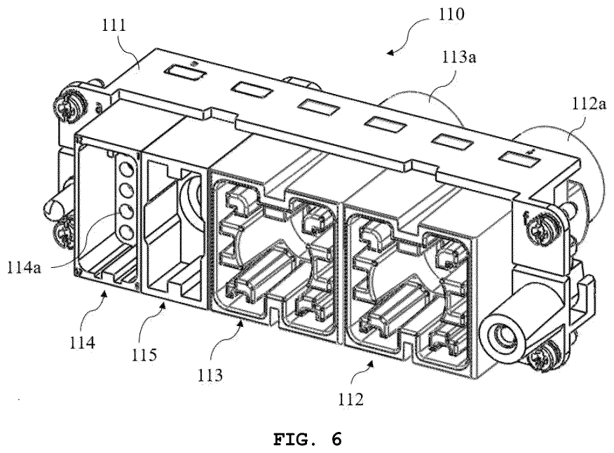

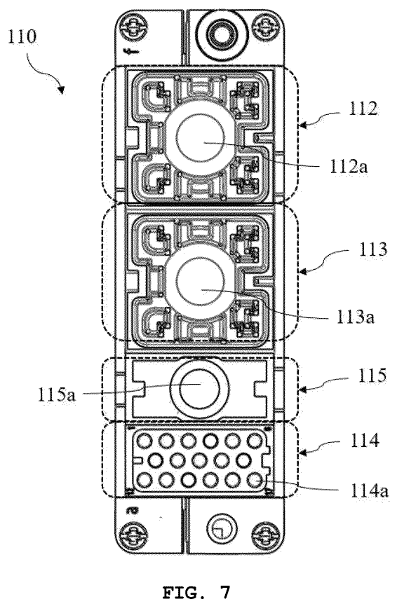

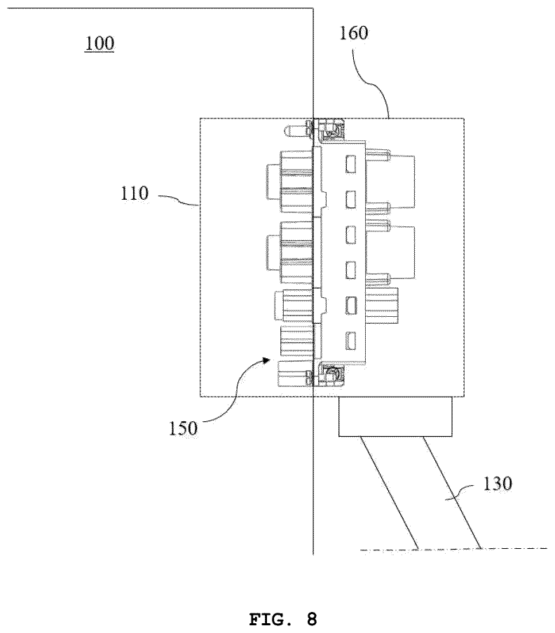

Referring to FIGS. 6 and 7, the charger connector 110 may be provided at one side of the charger 100, and may include a support frame 111, a charger +DC part 112 and a charger −DC part 113 that are a charger power part provided on the inside of the support frame 110, a charger signal part 114 to which signal lines are connected, and a charger ground part 115 having a ground hole 115a into which a ground wire to the ground is inserted.

The charger +DC part 112 and the charger −DC part 113 may have a first insertion conduit 112a and a second insertion conduit 113a into which power lines are inserted, formed respectively.

A link member may be provided at an end of each of the power lines of the charger +DC part 112 and the charger −DC part 113.

In the charger signal part 114, the plurality of insertion holes 114a may be formed into which a plurality of signal lines and link members formed at ends of the signal lines are inserted.

Accordingly, the link pins of the power part and the ground part 155 of the cable connector 150 may be detachably linked to the link members of the charger connector 110, respectively.

The charger connector 110 may serve as a female connector (socket), and the cable connector 150 may serve as a male connector (plug).

The power part, the charger signal part 114, and the charger ground part 115 included in the charger connector 110 serve as a female connector, so these may be provided partitioned by partition walls in the body of the charger connector 110.

In an embodiment of the present disclosure, the charger connector 110 and the cable connector 150 have been described as having a rectangular-shaped structure, but without being limited thereto, the charger connector 110 and the cable connector 150 may be provided in a number of different shapes. For example, the charger connector 110 and the cable connector 150 may be formed in a circular or rhombic shape.

According to an embodiment of the present disclosure, the cable connector 150 may be in the form of modules.

The charging cable 130 may be provided by collecting the power lines and the signal lines and wrapping the same in a sheath.

The signal lines of the signal part 154 may be connected into the charging cable 130 and connected to the charging connector 140 provided at one end of the charging cable 130. Herein, the signal lines to be connected may be determined according to the type of the charging connector 140 and connected. Accordingly, the number of signal lines to be connected may vary according to the type of the charging connector 140.

In addition, according to the present disclosure, a clamping member 170 may be provided for clamping to maintain a firm coupling state without separation after the charger connector 110 of the charger 100 is linked with the cable connector 150.

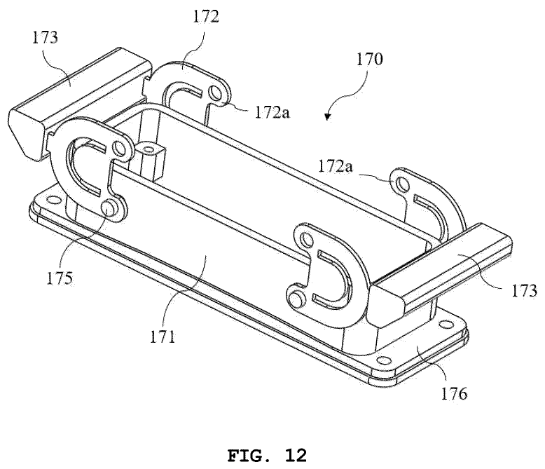

Referring to FIG. 12, the clamping member 170 may include a housing 171 for covering the charger connector 110, hook members 172 respectively formed at opposite edges of the housing 171, and handle members 173 connected to the hook members 172 to protrude from opposite sides of the housing 171.

The hook members 172 may be provided with locking protrusions 172a, and may be rotatably coupled to fixed projections 175 fixed at the housing 171.

In addition, the hood 160 may be provided with locking projections 161 that allow the hook members 172 to lock thereon.

The locking projections 161 and the fixed projections 175 may be fixed by coupling, for example, structures such as screws or bolts to the hood 160 and the housing 171, respectively.

A coupling surface 176 to be coupled to the charger 100 may be formed at the outer circumferential surface of the housing 171.

The handle members 173 may allow the charger connector 110 inserted in the housing 171 and the cable connector 150 inserted in the hood 160 to be easily separated from a coupled state. That is, the handle members 173 are grasped and rotated in a direction that unlocks the locked state caused by the hook members 172, so the cable connector 150 is easily separated from the charger connector 110. Conversely, the handle members 173 are grasped and rotated in a direction that locks through the hook members 172, so the cable connector 150 is maintained firmly coupled to the charger connector 110.

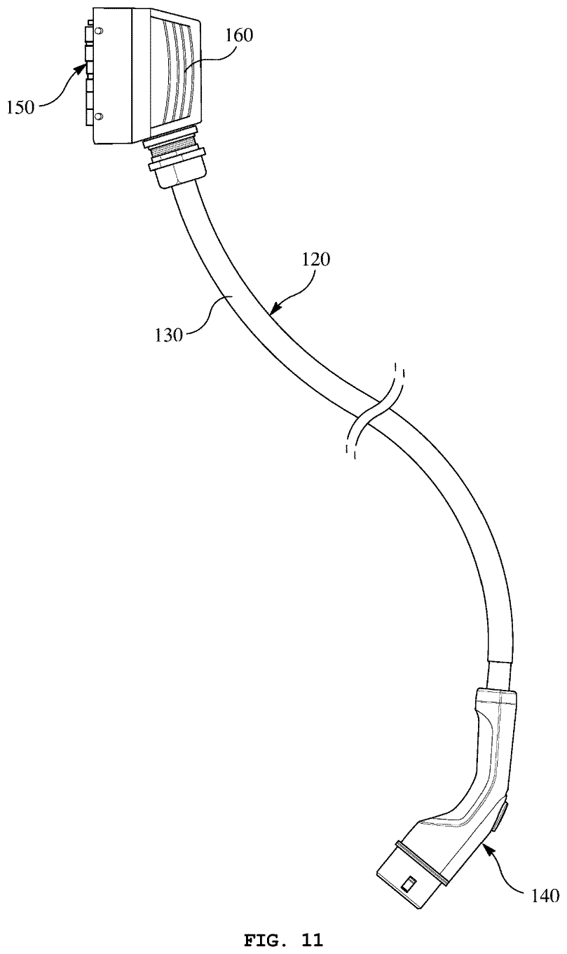

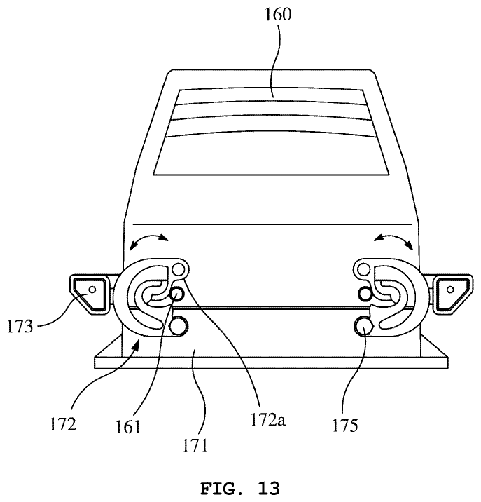

Referring to FIGS. 11 and 13, the clamping member 170 may be installed at the charger 100 while the charger connector 110 is inserted in the housing 171. Accordingly, when connected to the charger connector 110, the cable connector 150 may be clamped by the clamping member 170. FIG. 13 is a diagram illustrating a process of being clamped by the clamping member 170.

When the charger connector 110 is coupled with the cable connector 150, the hood 160 and the housing 171 provided to cover the charger connector 110 face each other. Then, the locking protrusions 172a of the hook members 172 formed on the sides of the housing 171 are fitted on the locking projections 161 formed at the hood 160 for locking. Thus, locking is achieved against the force of moving apart from each other while the charger connector 110 is coupled with the cable connector 150, thereby maintaining the firm coupling state.

In other words, when the force of moving apart from each other while the charger connector 110 is coupled with the cable connector 150 acts, the locking projections 161 of the hood 160 try to move away from the housing 171. At this time, the locking projections 161 are caught and prevented from moving by the locking protrusions 172a of the hook members 172, so the hood 160 and the housing 171 remain coupled without moving apart from each other.

One side of the cable connector 150 may be linked to the charger connector 110 of the charger 100, and the opposite side of the cable connector 150 may be connected to the charging cable 130.

According to the present disclosure, the common cable connector 150 detachably linked to the charger connector 110 of the charger 100 is provided one end of the charging cable 130, and the charging connector 140 is provided at the other end of the charging cable 130, thereby forming the charging cable assembly 120. There may be several types of charging cable assemblies 120.

According to the present disclosure, charging cable assemblies 120 equipped with various types of charging connectors 140 may be stored in a storage part 300, and a charging cable assembly 120 that fits a user's electric vehicle 10 may be linked to the charger 100 for use.

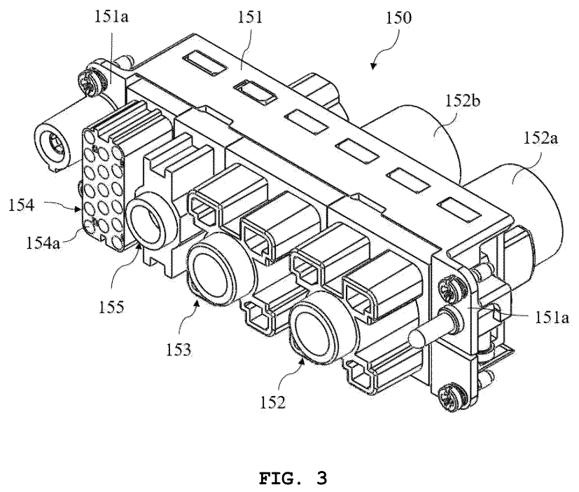

Referring to FIG. 2, the storage part 300 may be provided beside the charger 100. When a user approaches the charger 100 for the charging operation, the user may take a suitable charging cable assembly out of the storage part 300 for use.

The storage part 300 may be in the form of, for example, a cabinet. That is, the storage part 300 may include a space part in which a plurality of charging cable assemblies 120 are stored, and a door 302 that is opened and closed.

The storage part 300 may include a communication part 310 for communicating with the controller 200, and a door lock 320 for performing locking and unlocking operations according to control signals from the controller 200 through communication using the communication part 310.

The door 302 may be configured to be opened only to a user who has undergone a predetermined verification procedure, and may include any of a transparent body with a visible interior, a semi-transparent body, or an opaque body.

In addition, the charger 100 may be provided with the controller 200 for performing overall operations for charging. For the operation of the controller 200, the charger 100 may have a control panel (display), such as a touch panel, formed. Through the control panel, the user may follow various procedures for charging.

Referring to FIG. 9, the controller 200 may include: an input part 210 for inputting information on an electric vehicle of a user; a user authentication part 220 for the user for charging; a charging type determination part 230 for providing a charging connector 140 suitable for the electric vehicle 10 of the user; a door actuating part 240 for opening the door 302 of the storage part 300 when the suitable charging connector 140 is selected; a payment part 250 for paying a charging cost when charging is completed; and a communication part 260 for exchanging signals with the storage part 300.

The input part 210 may input information on an electric vehicle 10 to be charged. The information on the electric vehicle 10 may relate to the vehicle number of the electric vehicle 10 and a type (vehicle model) of the electric vehicle 10.

In addition, the user authentication part 220 is for an authentication procedure for the user to charge the electric vehicle 10, and user information may be input.

The user information may be at least one selected from the group of the user's name, phone number, resident registration number, and vehicle information (the vehicle number and the vehicle model).

The user information may be information registered and stored in the management server 400 in advance through the user's terminal.

The user authentication part 220 may compare the vehicle information input through the input part 210 and the pre-stored user information, and may complete authentication of the user according to the comparison result. The input vehicle number information is compared with the vehicle number information in the pre-stored user information, and if they match, the authentication procedure for the user may be completed.

When the user inputs the vehicle number into the input part 210 of the controller 200 provided at the charger 100, the user authentication part 220 may perform the user authentication and the charging type determination part 230 may determine the charging connector 140 that fits the electric vehicle 10 of the user and notify the user of the charging connector 140.

The information notified to the user may be an identification number or a model number for the plurality of charging cable assemblies 120 arranged in the storage part 300 in advance.

Accordingly, in the storage part 300, a unique identification means (i.e., identifier) for each of the charging cable assemblies 120 is provided for arrangement in a distinguishable manner, and the identifier may include the identification number or the model number.

Then, the door actuating part 240 may unlock the door lock 320 through communication with the storage part 300, and the user may open the door 302 of the storage part 300 and take the charging cable assembly 120 of the corresponding type out.

After taking the suitable charging cable assembly 120 out, the cable connector 150 of the charging cable assembly 120 is linked to the charger connector 110 provided at the charger 100, and the charging connector 140 provided at the opposite end of the charging cable 130 is coupled to the charging port 12 of the electric vehicle 10 to perform charging.

When charging of the electric vehicle 10 is completed, the charging connector 140 is separated from the charging port 12, and the cable connector 150 is separated from the charger connector 110 of the charger 100. Next, the charging cable assembly is returned to its position in the storage part 300 and the door 302 is closed, thereby completing the whole charging operation.

If, after the charging operation is completed, the user leaves without returning the charging cable assembly 120 to its position in the storage part 300, the management server 400 may recognize this situation and charge the user a cost for a penalty.

Accordingly, the storage part 300 includes receiving parts 330 at the positions at which the respective charging cable assemblies 120 are placed, and the receiving parts 330 are provided with sensors (weight sensors). When a charging cable assembly 120 is not placed for a predetermined period of time or longer, it is determined that the charging cable assembly 120 is not placed in its position in the storage part 300 and neglected. Such information may be transmitted to the management server 400.

The information detected by the sensors provided at the receiving parts 330 is transmitted by the controller 200 of the charger 100 to the management server 400 for storage.

Since the user needs to undergo the user authentication part 220, the user information of the user may be stored in the management server 400. Accordingly, when the user neglects the charging cable assembly 120, the management server 400 may charge the user for a penalty.

According to the present disclosure, various procedures for charging an electric vehicle may be performed through the charger 100. However, when a plurality of chargers 100 are installed, the plurality of chargers 100 are connected to a kiosk and various procedures may be performed through the kiosk. Accordingly, the kiosk may transmit and receive information to and from the storage part 300 and the management server 400 through communication.

As described above, according to the present disclosure, when electric vehicles 10 having different types of charging ports 12 are charged by the charger 100, charging connectors 140 that fit the electric vehicles 10 are provided, whereby users can easily conduct the charging operation.

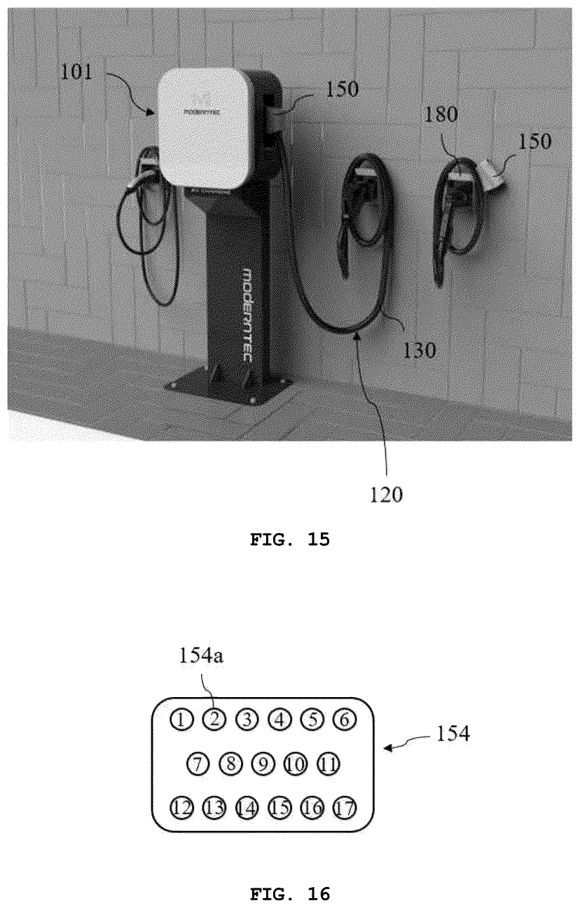

FIG. 15 is a diagram illustrating another example of installation of a charger according to the present disclosure. The charger 101 is installed as a stand type, and beside the charger 101, a plurality of holding members 180 for a plurality of charging cable assemblies 120 are provided protruding from the wall, and the plurality of charging cable assemblies 120 may be rolled and held at the holding members 180.

The holding members 180 or the charging cable assemblies 120 are represented by identifier (e.g., identification numbers) indicating types. Thus, after user authentication at the charger 101, the identifier of the charging cable assembly 120 that fits the user's electric vehicle may be notified.

Herein, the charger 101 may have the same function as the charger 100 described in the above embodiment, but may have a structure not provided with the storage part 300. The holding members 180 may be provided with sensors to recognize the charging cable assemblies 120 held thereon. When the charging cable assembly 120 is not held at the holding member 180 for a predetermined period of time or longer, the controller 200 may recognize mismanagement.

Accordingly, the charging cable assemblies 120 are held on the wall by respective charging types. After a user uses the charging cable assembly 120 corresponding to his or her vehicle, if the user does not place the charging cable assembly 120 on the wall and neglects the charging cable assembly 120 anywhere or damages the charging cable assembly 120, the management server 400 may recognize the user. This is because when the charger 101 is used, the user information is input through user authentication. Thus, when the charging cable assembly 120 is not properly placed, the user may be charged a cost for a penalty. This may prevent situations such as breakage, shorten lifespan, and loss caused by mismanagement of the charging cable assemblies 120.

Features, structures, and effects described in the embodiments above are included in at least one embodiment of the present disclosure, and are not necessarily limited to only one embodiment. In addition, the features, structures, and effects of each embodiment may be combined or modified with respect to other embodiments by those skilled in the art to which the embodiments belong. Accordingly, contents related to the combination and modification should be construed as being included in the scope of the present disclosure.

In addition, although the above description focuses on the embodiments, this is only an example and does not limit the present disclosure, and those skilled in the art to which the present disclosure belongs will understand that various modifications and applications not exemplified above are possible without departing from the essential characteristics of the present disclosure. For example, each element specifically shown in the embodiments may be modified and implemented. In addition, differences related to these modifications and applications should be construed as being included in the scope of the present disclosure defined in the appended claims.

What is claimed is:

1. A charging station comprising:
a charger configured to charge an electric vehicle;
a charging cable assembly detachably provided on the charger; and
a storage part configured to store the charging cable assembly therein,
wherein the charging cable assembly comprises:
a charging connector configured to be linked to the electric vehicle for charging;
a charging cable connected to the charging connector; and
a common cable connector provided at one end of the charging cable and detachably linked with the charger, and
the storage part is provided with identifier allowing a plurality of the charging cable assemblies of different charging types to be stored in a distinguishable manner.

2. The charging station of claim 1, wherein the charger comprises a controller comprising:
an input part configured to input information on an electric vehicle of a user;
a user authentication part for the user for charging;
a charging type determination part configured to provide the charging connector that fits the electric vehicle of the user; and
a communication part configured to communicate with the storage part,
wherein the charger is provided with a charger connector linked with the charging cable assembly,
the plurality of the charging cable assemblies of the different charging types are provided, and
the charger connector and the cable connectors of the plurality of the charging cable assemblies of the different charging types are configured to be always fitted and linked with each other.

3. The charging station of claim 2, wherein the cable connector comprises:
a power part provided with power lines; and
a signal part provided with a plurality of signal lines, and
wherein, according to the charging type of the charging connector, line connections are made by varying the number of the line connections between the signal lines of the signal part and the charging connector or a connection state of the signal lines of the signal part of the cable connector linked with the charger connector of the charger varies.

4. The charging station of claim 3, wherein the charger connector is covered by a housing,
the cable connector is covered by a hood, and
the charging station further comprises a clamping member configured to prevent the charger connector and the cable connector from moving apart from each other when the charger connector is coupled with the cable connector.

5. The charging station of claim 4, wherein the clamping member comprises:
hook members rotatably provided at the housing; and
locking protrusions with which the hook members are provided,
the hood is provided with locking projections on which the locking protrusions are locked; and
when the charger connector is coupled with the cable connector, the housing and the hood face each other, the locking projections are caught by the locking protrusions, and the housing and the hood remain coupled without moving apart from each other.

6. The charging station of claim 2, wherein the storage part comprises a space in which the plurality of the charging cable assemblies are placed, and a door provided with a door lock and configured to be opened and closed,
the controller is configured to, when receiving information of the electric vehicle to be charged, perform control such that the door is opened through the door lock of the storage part,
the controller is configured to notify, among the plurality of the charging cable assemblies provided in the storage part, the charging cable assembly corresponding to the identifier selected, and
the charging type determination part is configured to provide, when the charging connector of the charging type that fits the electric vehicle to be charged is selected, the identifier corresponding to the selected charging connector.

7. A charging station comprising:
a charger configured to charge an electric vehicle; and
a charging cable assembly detachably provided on the charger,
wherein the charging cable assembly comprises:
a charging connector configured to be linked to the electric vehicle for charging;
a charging cable connected to the charging connector; and
a common cable connector provided at one end of the charging cable and detachably linked with the charger,
the charger is provided with a charger connector linked with the charging cable assembly,
the cable connector comprises:
a power part provided with power lines; and
a signal part provided with a plurality of signal lines, and
according to a charging type of the charging connector, line connections are made by varying the number of the line connections between the signal lines of the signal part and the charging connector or a connection state of the signal lines of the signal part of the cable connector linked with the charger connector of the charger varies.

8. The charging station of claim 7, further comprising:
a storage part configured to store the charging cable assembly therein,
wherein the storage part comprises:
a space in which a plurality of the charging cable assemblies are placed, and a door configured to be opened and closed; and
the charger is provided with a controller configured to, when receiving vehicle information of a user's electric vehicle to be charged, perform control such that the door of the storage part is opened.

9. The charging station of claim 8, wherein the storage part is provided with the door equipped with a door lock,
a charging type determination part is configured to provide, when the charging connector of the charging type that fits the electric vehicle to be charged is selected, an identifier corresponding to the selected charging connector,
the controller is configured to open the door lock of the storage part, and
the controller is configured to notify, among the plurality of the charging cable assemblies provided in the storage part, the charging cable assembly corresponding to the identifier selected.

10. The charging station of claim 7, wherein a plurality of the charging cable assemblies of different charging types are provided, and
the charger connector and the cable connectors of the plurality of the charging cable assemblies of the different charging types are configured to be always fitted and linked with each other.

11. The charging station of claim 8, wherein, in the storage part, a receiving part configured to receive the charging cable assembly is provided,
the receiving part is provided with a sensor configured to detect a state in which the charging cable assembly is received, and
when the sensor detects a state in which the charging cable assembly is not received for a predetermined period of time or longer, the controller is configured to determine that the charging cable assembly is taken out of the storage part and used, but is not received in the receiving part, and charge the user for a penalty through user information stored in a management server.

12. The charging station of claim 7, wherein the charger connector is covered by a housing,
the cable connector is covered by a hood, and
the charging station further comprises a clamping member configured to prevent the charger connector and the cable connector from moving apart from each other when the charger connector is coupled with the cable connector.

13. The charging station of claim 12, wherein the clamping member comprises:
hook members rotatably provided at the housing; and
locking protrusions with which the hook members are provided,
the hood is provided with locking projections on which the locking protrusions are locked, and
when the charger connector is coupled with the cable connector, the housing and the hood face each other, the locking projections are caught by the locking protrusions, and the housing and the hood remain coupled without moving apart from each other.

14. The charging station of claim 7, wherein a plurality of holding members are provided on a wall beside the charger,
the holding members are configured to hold the charging cable assemblies by charging types, and
the holding members or the charging cable assemblies are represented by identifier indicating the charging types.

15. The charging station of claim 14, wherein the charger comprises a controller comprising
an input part configured to input information on an electric vehicle of a user;
a user authentication part for the user for charging; and
a charging type determination part configured to provide the charging connector that fits the electric vehicle of the user, and
after the user authentication part performs user authentication, the identifier of the charging cable assembly that fits the electric vehicle is notified.

16. The charging station of claim 7, wherein the cable connector comprises:
a charger power part linked with the power part of the cable connector; and
a charger signal part linked with the signal part of the cable connector.

17. The charging station of claim 16, wherein an exterior of the cable connector is provided with a hood,
inside the hood, a coupling frame, the power part, and the signal part are embedded,
in the signal part, a plurality of connection holes for connection with the plurality of signal lines are formed,
the power part comprises a +DC part that is a positive direct current power part and a −DC part that is a negative direct current power part,
the +DC part and the −DC part are respectively provided with a first connection conduit and a second connection conduit into which the power lines are inserted, and
the first connection conduit is provided with a positive (+) direct current power line among the power lines therein, and the second connection conduit is provided with a negative (−) direct current power line among the power lines therein.

18. The charging station of claim 17, wherein charging types of the cable connectors are distinguished according to the signal lines and link pins inserted into the plurality of connection holes formed in the signal part.

19. A charging station comprising:
a charger configured to charge an electric vehicle;
a charging cable assembly detachably provided on the charger; and
a storage part configured to store the charging cable assembly therein,
wherein the charging cable assembly comprises:
a charging connector configured to be linked to the electric vehicle for charging;
a charging cable connected to the charging connector; and
a common cable connector provided at one end of the charging cable and detachably linked with the charger,
the storage part is provided with identifier allowing a plurality of the charging cable assemblies of different charging types to be stored in a distinguishable manner,
the charger comprises a controller comprising:
an input part configured to input information on an electric vehicle of a user;
a user authentication part for the user for charging;
a charging type determination part configured to provide the charging connector that fits the electric vehicle of the user; and
a communication part configured to communicate with the storage part,
the charger is provided with a charger connector linked with the charging cable assembly,
the plurality of the charging cable assemblies of the different charging types are provided,
the charger connector and the cable connectors of the plurality of the charging cable assemblies of the different charging types are configured to be always fitted and linked with each other,
the cable connector comprises:
a power part provided with power lines; and
a signal part provided with a plurality of signal lines,
according to the charging type of the charging connector, line connections are made by varying the number of the line connections between the signal lines of the signal part and the charging connector or a connection state of the signal lines of the signal part of the cable connector linked with the charger connector of the charger varies,
the charger connector is covered by a housing,
the cable connector is covered by a hood,
the charging station further comprises a clamping member configured to prevent the charger connector and the cable connector from moving apart from each other when the charger connector is coupled with the cable connector,
the clamping member comprises:
hook members rotatably provided at the housing; and
locking protrusions with which the hook members are provided,
the hood is provided with locking projections on which the locking protrusions are locked, and
when the charger connector is coupled with the cable connector, the housing and the hood face each other, the locking projections are caught by the locking protrusions, and the housing and the hood remain coupled without moving apart from each other,
the storage part comprises a space in which the plurality of the charging cable assemblies are placed, and a door provided with a door lock and configured to be opened and closed,
the controller is configured to, when receiving vehicle information of the electric vehicle to be charged, perform control such that the door is opened through the door lock of the storage part,
the controller is configured to notify, among the plurality of the charging cable assemblies provided in the storage part, the charging cable assembly corresponding to the identifier selected, and
the charging type determination part is configured to provide, when the charging connector of the charging type that fits the electric vehicle to be charged is selected, the identifier corresponding to the selected charging connector.

20. The charging station of claim 19, wherein, in the storage part, a receiving part configured to receive the charging cable assembly is provided,
the receiving part is provided with a sensor configured to detect a state in which the charging cable assembly is received, and
when the sensor detects a state in which the charging cable assembly is not received for a predetermined period of time or longer, the controller is configured to determine that the charging cable assembly is taken out of the storage part and used, but is not received in the receiving part, and charge the user for a penalty through user information stored in a management server.
